(19) United States
(12) Patent Application Publication
(10) Pub. No.: US 2017/0269847 A1
(43) Pub. Date: Sep. 21, 2017

(54) Method and Device for Differential Data Backup

(71) Applicant: Huawei Technologies Co., Ltd., Shenzhen (CN)

(72) Inventors: Feng Liang, Shenzhen (CN); Xuesong Wang, Chengdu (CN); Jun You, Chengdu (CN); Ji Ouyang, Chengdu (CN); Weixin Tu, Shanghai (CN)

(21) Appl. No.: 15/611,456

(22) Filed: Jun. 1, 2017

Related U.S. Application Data
(63) Continuation of application No. PCT/CN2016/075269, filed on Mar. 2, 2016.

(51) Int. Cl. G06F 3/06

(52) U.S. Cl. CPC G06F 3/065; G06F 3/0619; G06F 3/064; G06F 3/067

(57) ABSTRACT

A method for a source storage device replicating data to a backup storage device, where the source storage device identifies a current fingerprint set based on an identifier of a current backup period. Each of the plurality of fingerprint sets corresponds to a backup period. The current fingerprint set includes one or more fingerprints and identifies one or more data blocks respectively. The one or more data blocks are received by the source storage device between an end moment of a previous backup period and a start moment of the current backup period. Further, the source storage device obtains the one or more data block and sends them the backup storage device. Therefore, data backup efficiency can be improved.

### CROSS-REFERENCE TO RELATED APPLICATIONS

This application is a continuation of International Patent Application No. PCT/CN2016/075269 filed on Mar. 2, 2016, which is hereby incorporated by reference in its entirety.

### TECHNICAL FIELD

Embodiments of the present disclosure relate to the field of storage technologies, and in particular, to a method and a device for differential data backup.

### BACKGROUND

In a remote replication technology, before a source storage device sends data to a backup storage device, the source storage device needs to shard the data into multiple data blocks, perform calculation to obtain fingerprints of all data blocks, and send the fingerprints to the backup storage device. The backup storage device compares the received fingerprints with a fingerprint that has been stored by the backup storage device in order to determine a fingerprint in the received fingerprints that is not stored in the backup storage device, and feeds back a comparison result to the source storage device. The source storage device filters the data according to the comparison result fed back by the backup storage device in order to determine incremental data. Because the source storage device needs to send the fingerprints of all the data blocks to the backup storage device, plenty of computing resources and network bandwidth need to be consumed.

### SUMMARY

The present disclosure provides a method and a device for differential data backup. A source storage device can determine, according to a correspondence between an identifier of a backup period and a fingerprint information set, a fingerprint information set corresponding to a current backup period, and determine, according to the determined fingerprint information set, a data block that needs to be backed up. Therefore, data backup efficiency can be improved, and consumption of computing resources and network resources can be reduced.

According to a first aspect, a method for differential data backup is provided, where the method is applied to a storage system, the storage system includes a source storage device and a backup storage device, the method is executed by the source storage device, and the method includes determining, according to an identifier of a current backup period and a correspondence between an identifier of a backup period and a fingerprint information set, a fingerprint information set corresponding to the current backup period, where the fingerprint information set includes fingerprint information of a target data block stored by the source storage device between a start moment of the current backup period and an end moment of a previous backup period, and the target data block is different from all data blocks stored by the source storage device before the end moment of the previous backup period, obtaining the target data block according to the fingerprint information of the target data block, and sending the target data block to the backup storage device.

In this way, according to the method for differential data backup in an embodiment of the present disclosure, the source storage device can determine, only according to the identifier of the current backup period and the correspondence between an identifier of a backup period and a fingerprint information set, a data block that needs to be backed up in the current backup period, and send, to the backup storage device, the data block that needs to be backed up. Therefore, data backup efficiency can be improved, and consumption of computing resources and network resources can be reduced.

With reference to the first aspect, in a first possible implementation manner of the first aspect, the method further includes sending a fingerprint of the target data block to the backup storage device.

In this way, the backup storage device can directly store the received fingerprint, without performing fingerprint calculation such that computing resources of the backup storage device can be reduced.

With reference to the first aspect or the first possible implementation manner of the first aspect, in a second possible implementation manner of the first aspect, the fingerprint information of the target data block is stored in a linked list, a head node of the linked list stores the identifier of the current backup period, the i^{th} element node of the linked list stores fingerprint information of the i^{th} target data block of target data blocks, k is a total quantity of the target data blocks and is an integer greater than or equal to 1, and i is an integer greater than 0 and less than or equal to k.

The source storage device stores the fingerprint information of the target data block in a linked list manner, can record the fingerprint information of the target data block in a deduplication process, and can directly obtain, from the fingerprint information stored in the linked list, the fingerprint information set corresponding to the current backup period when needed. Therefore, computing resources and computing time can be reduced.

With reference to the second possible implementation manner of the first aspect, in a third possible implementation manner of the first aspect, the fingerprint information of the i^{th} target data block is a fingerprint of the i^{th} target data block, and the i^{th} element node of the linked list further stores a mapping relationship between the fingerprint of the i^{th} target data block and a storage address of the i^{th} target data block, and obtaining the target data block according to the fingerprint information of the target data block includes obtaining the i^{th} target data block according to the fingerprint of the i^{th} target data block and the mapping relationship between the fingerprint of the i^{th} target data block and the storage address of the i^{th} target data block.

According to a second aspect, a method for differential data backup is provided, where the method is applied to a storage system, the storage system includes a source storage device and a backup storage device, the method is executed by the source storage device, and the method includes determining, according to an identifier of a current backup period and a correspondence between an identifier of a backup period and a fingerprint information set, a fingerprint information set corresponding to the current backup period, where the fingerprint information set includes fingerprint information of a target data block stored by the source storage device between a start moment of the current backup period and an end moment of a previous backup period, and the target data block is different from all data blocks stored by the source storage device before the end moment of the previous backup period, sending a fingerprint, corresponding to the fingerprint information of the target data block, of the target data block to the backup storage device, receiving a feedback message sent by the backup storage device, where the feedback message is used to indicate a differential fingerprint, and the differential fingerprint is a subset of the fingerprint of the target data block and different from a fingerprint of a data block stored in the backup storage device, and sending a target data block corresponding to the differential fingerprint to the backup storage device.

Compared with the other approaches, the source storage device according to an embodiment of the present disclosure only needs to send the fingerprint of the target data block stored between the start moment of the current backup period and the end moment of the previous backup period to the backup storage device for fingerprint comparison, with no need to send fingerprints of all data blocks included in data received by the source storage device between the start moment of the current backup period and the end moment of the previous backup period to the backup storage device for fingerprint comparison, and determines, according to a comparison result, a data block that needs to be backed up in the current backup period. The target data block is different from all the data blocks stored by the source storage device before the end moment of the previous backup period. Therefore, a quantity of the fingerprints sent to the backup storage device can be reduced, thereby reducing consumption of network resources and time consumed by the backup storage device for fingerprint comparison.

With reference to the second aspect, in a first possible implementation manner of the second aspect, the source storage device has a deduplication function, the backup storage device has a deduplication function, and a deduplication range of the source storage device is less than a deduplication range of the backup storage device.

According to a third aspect, a storage device is provided, where the storage device is applied to a storage system, the storage system includes the storage device and a backup storage device, and the storage device is configured to execute the method according to the first aspect or any possible implementation manner of the first aspect. Further, the storage device includes a unit configured to execute the method according to the first aspect or any possible implementation manner of the first aspect.

According to a fourth aspect, a storage device is provided, where the storage device is applied to a storage system, the storage system includes the storage device and a backup storage device, and the storage device is configured to execute the method according to the second aspect or the possible implementation manner of the second aspect. Further, the storage device includes a unit configured to execute the method according to the second aspect or the possible implementation manner of the second aspect.

According to a fifth aspect, a storage device is provided, where the storage device is applied to a storage system, the storage system includes the storage device and a backup storage device, and the storage device includes a processor, a memory, and a transmitter, where the processor, the memory, and the transmitter are connected using a bus system, the memory is configured to store an instruction, and the processor is configured to execute the instruction stored by the memory, enabling the storage device to execute the method according to the first aspect or any possible implementation manner of the first aspect.

According to a sixth aspect, a storage device is provided, the storage system includes the storage device and a backup storage device, and the storage device includes a processor, a memory, a transmitter, and a receiver, where the processor, the memory, the transmitter, and the receiver are connected using a bus system, the memory is configured to store an instruction, and the processor is configured to execute the instruction stored by the memory, enabling the storage device to execute the method according to the second aspect or the possible implementation manner of the second aspect.

According to a seventh aspect, a computer readable medium is provided configured to store a computer program, where the computer program includes an instruction that is used to execute the method according to the first aspect or any possible implementation manner of the first aspect.

According to an eighth aspect, a computer readable medium is provided configured to store a computer program, where the computer program includes an instruction to execute the method according to the second aspect or the possible implementation manner of the second aspect.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts.

FIG. 1 is a diagram of an application scenario according to an embodiment of the present disclosure;

FIG. 2 is a schematic block diagram of a controller of a source storage device according to an embodiment of the present disclosure;

FIG. 3 is a schematic flowchart of a method for differential data backup according to an embodiment of the present disclosure;

FIG. 4 is a schematic block diagram of a structure of a linked list according to an embodiment of the present disclosure;

FIG. 5 is a schematic flowchart of a method for differential data backup according to another embodiment of the present disclosure;

FIG. 6 is a schematic block diagram of a storage device according to an embodiment of the present disclosure; and

FIG. 7 is a schematic block diagram of a storage device according to another embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are a part rather than all of the embodiments of the present disclosure.

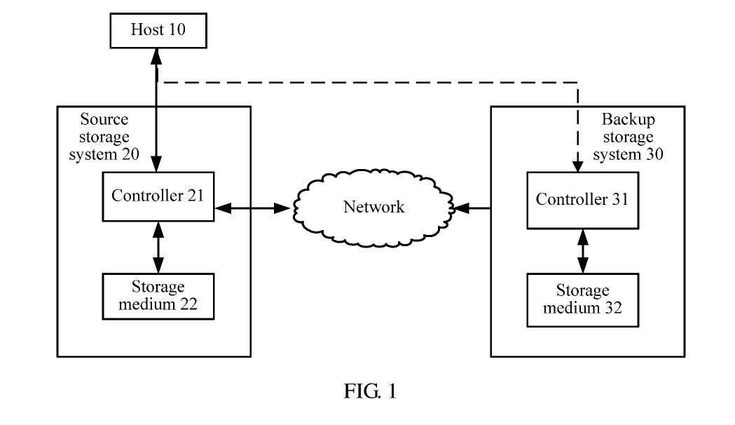

FIG. 1 is a diagram of an application scenario according to an embodiment of the present disclosure. As shown in FIG. 1, a host 10, a source storage system 20, and a backup storage system 30 are included. The host 10 is connected to both the source storage system 20 and the backup storage system 30. However, the host 10 is connected to only the source storage system 20 in normal cases, and is connected to the backup storage system 30 only when the backup storage system 30 is required to provide a service when the source storage system 20 is faulty. The source storage system 20 is connected to the backup storage system 30 using a network, allowing bidirectional data transmission.

The source storage system 20 may be a storage device, and may be referred to as “a source storage device”. As shown in FIG. 1, the source storage device 20 includes a controller 21 and a storage medium 22. The backup storage system 30 may be a storage device, and may be referred to as “a backup storage device”. As shown in FIG. 1, the backup storage device 30 includes a controller 31 and a storage medium 32.

The following describes a structure and a function of the source storage device 20.

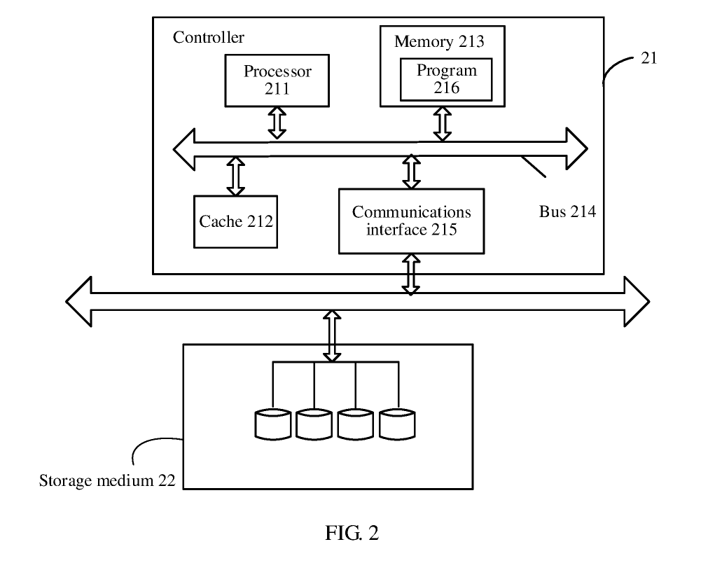

For example, as shown in FIG. 2, the controller 21 of the source storage device 20 mainly includes a processor 211, a cache 212, a memory 213, a communications bus (designated as a bus) 214, and a communications interface 215. The processor 211, the cache 212, the memory 213, and the communications interface 215 communicate with each other using the bus 214.

The processor 211 may be a central processing unit (CPU) or an application-specific integrated circuit (ASIC), or may be configured as one or more integrated circuits for implementing this embodiment of the present disclosure. The processor 211 is configured to receive a data object (the data object refers to an object including actual data, and may be block data, or may be data in a file form or in another form) from the host 10, perform specific processing on the data object, and send a processed data object to the storage medium 22.

The communications interface 215 is configured to communicate with the host 10, the backup storage device 30, or the storage medium 22.

The memory 213 is configured to store a program 216. The memory 213 may include a high-speed random access memory (RAM), and may further include a non-volatile memory (NVM), for example, at least one magnetic disk memory. It can be understood that the memory 213 may be any non-transitory machine-readable medium that can store program code, such as a RAM, a magnetic disk, a hard disk, an optical disc, a solid state disk (SSD), or an NVM.

The cache 212 is configured to temporarily store the data object received from the host 10 or a data object read from the storage medium 22. In addition, because a cache reads and writes data at a relatively high speed, for ease of reading, some frequently used information, for example, a logical address and write time of a data block, may be stored in the cache 212. The cache 212 may be any non-transitory machine-readable medium that can store data, such as a RAM, a storage-class memory (SCM), an NVM, a flash memory, or an SSD.

The cache 212 and the memory 213 may be disposed together or separately, which is not limited in this embodiment of the present disclosure.

The program 216 may include program code, and the program code includes a computer operating instruction. For a storage device having a deduplication function, the program code may include a deduplication module. The deduplication module is configured to perform deduplication before the data object received from the host 10 is sent to the storage medium 22.

The following briefly describes the deduplication function using the source storage device 20 as an example.

After receiving the data object sent by the host 10, the controller 21 may divide the data object into several data blocks of a same size. For each data block, the processor 211 determines whether the storage medium 22 stores a same data block. The processor 211 writes the data block into the storage medium 22 and sets a reference count of the data block to an initial value (for example, 1) if the storage medium 22 does not store a same data block, and the processor 211 does not need to write the stored data block into the storage medium 22 and increases a reference count of the data block by 1 if the storage medium 22 stores a same data block.

For how to determine whether the storage medium 22 stores a same data block, in a common practice, fingerprints of all data blocks stored in the storage medium 22 are pre-stored, and a fingerprint of each data block is obtained by calculating the data block according to a preset hash function. Then, a to-be-stored data block is calculated according to the hash function to obtain a fingerprint of the to-be-stored data block, and matching the fingerprint with the pre-stored fingerprints of all the data blocks is performed. It indicates that the storage medium 22 has stored a same data block if there is a same fingerprint. Otherwise, it indicates that the storage medium 22 does not store the to-be-stored data block. The fingerprints of all the data blocks may be stored in the cache 212, or may be stored in the storage medium 22. In addition, other manners may be used to determine whether the storage medium 22 stores a same data block, and are not enumerated herein.

It should be noted that, in this embodiment of the present disclosure, because the source storage device 20 has the deduplication function, fingerprint information of all data blocks in the source storage device 20 is stored in the cache 212 or the storage medium 22, and is referred to as a fingerprint information set in this embodiment. It can be understood that fingerprints, included in the fingerprint information set, of the data blocks are different. In addition, the processor 211 may separately store a fingerprint information set corresponding to each backup period. Fingerprint information of a data block may be optionally a fingerprint of the data block, or may be an index (for example, a pointer that points to a fingerprint of a data block) of the fingerprint of the data block. Therefore, when needing to back up differential data, the processor 211 may directly determine, according to the separately stored fingerprint information set corresponding to each backup period, a data block that needs to be backed up in each backup period, and send, to the backup storage device 30 for backup storage, the data block that needs to be backed up.

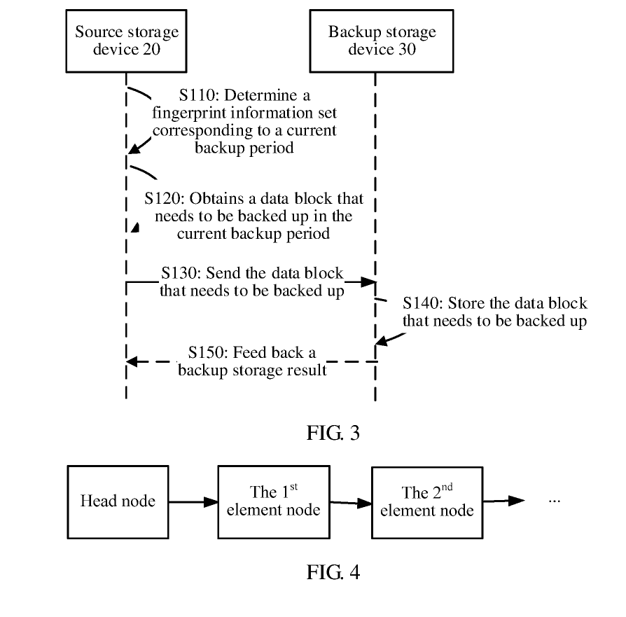

FIG. 3 is a schematic flowchart of a method for differential data backup according to an embodiment of the present disclosure. The method is applied to the source storage device 20 and the backup storage device 30 shown in FIG. 1. As shown in FIG. 3, the method includes the following steps.

Step S110: The source storage device 20 determines a fingerprint information set corresponding to a current backup period.

In this embodiment, the source storage device 20 may periodically back up differential data into the backup storage device 30, and each period is referred to as a backup period in this embodiment. The source storage device 20 may send differential data received in each backup period to the backup storage device 30. In this embodiment, because the differential data needs to be divided into several data blocks to determine whether there is a data block the same as a stored data block, the differential data may also be referred to as a differential data block. In addition, in this embodiment, because the source storage device 20 has a deduplication function, fingerprint information of all data blocks in the source storage device 20 is stored, and is referred to as a fingerprint information set in this embodiment. It can be understood that fingerprints, included in the fingerprint information set, of the data blocks are different. In addition to the fingerprint information set of all the data blocks, the source storage device 20 may separately store a fingerprint information set corresponding to the current backup period. Optionally, the fingerprint information set and the fingerprint information set corresponding to the current backup period may be stored in a storage medium, such as the storage medium 22 shown in FIG. 1, or may be stored in a cache, such as the cache 212 shown in FIG. 2.

The fingerprint information set corresponding to the current backup period includes fingerprint information of a target data block stored by the source storage device 20 between a start moment of the current backup period and an end moment of a previous backup period, and the target data block is different from all data blocks stored by the source storage device 20 before the end moment of the previous backup period. That is, the target data block is a data block that the source storage device 20 needs to back up into the backup storage device 30 in the current backup period.

Further, step S110 is performed by a processor, such as the processor 211 of the source storage device 20. The processor records fingerprint information of a target data block stored in a deduplication process when performing a deduplication operation on written data.

For example, the processor may store fingerprint information of a data block in a linked list, that is, the processor stores fingerprint information of a data block in a linked list manner. Further, the linked list may store fingerprint information of all data blocks, an identifier of a backup period, and a fingerprint information set, and there is a correspondence between the identifier of the backup period and the fingerprint information set. An implementation manner of the correspondence may be determined by an implementation manner of the linked list. Therefore, step S110 may include that the processor directly obtains, from the linked list according to an identifier of the current backup period and the correspondence between the identifier of the backup period and the fingerprint information set, the fingerprint information set corresponding to the current backup period.

For example, a structure of the linked list is shown in FIG. 4. A head node of the linked list stores the identifier of the backup period, the i^{th} element node of the linked list stores fingerprint information of the i^{th} target data block of target data blocks, k is a total quantity of the target data blocks and is an integer greater than or equal to 1, and i is an integer greater than 0 and less than or equal to k.

Optionally, the linked list may be stored in the storage medium, or may be stored in the cache, and the identifier of the backup period may include a start time and/or an end time of the backup period.

It should be understood that there may further be another manner of storing fingerprint information of a data block. For example, the fingerprint information of the data block may be stored in a stack or queue manner. This embodiment does not need to limit the manner of storing the fingerprint information of the data block.

Step S120: The source storage device 20 obtains, according to the fingerprint information set corresponding to the current backup period, a data block that needs to be backed up in the current backup period.

Optionally, fingerprint information may be an index of a fingerprint of a target data block, for example, may be a pointer that points to the fingerprint. In this case, after determining the fingerprint information set corresponding to the current backup period, the processor may determine, according to a value of the pointer of the fingerprint information set, a fingerprint corresponding to the current backup period, and then obtain a target data block according to the fingerprint and a mapping relationship, stored in the storage medium or the cache, between the fingerprint and a storage address of a data block, where the target data block is the data block that needs to be backed up in the current backup period.

Optionally, fingerprint information may be a fingerprint of a target data block. In this case, after determining the fingerprint information set corresponding to the current backup period, the processor may directly obtain the target data block according to a fingerprint included in the fingerprint information set and a mapping relationship, stored in the storage medium or the cache, between the fingerprint and a storage address of the corresponding data block.

Further, the i^{th} element node of the linked list shown in FIG. 4 further stores a mapping relationship between a fingerprint of the i^{th} target data block and a storage address of the i^{th} target data block. Therefore, the processor may directly obtain a target data block according to a fingerprint stored in the linked list and a mapping relationship between the fingerprint and a storage address of the target data block.

Further, step S120 may be performed by the processor of the source storage device 20.

Step S130: The source storage device 20 sends, to the backup storage device 30, the data block that needs to be backed up.

The processor sends, to the backup storage device 30 through a communications interface, such as the communications interface 215 shown in FIG. 2, the data block that needs to be backed up.

Step S140: The backup storage device 30 stores the data block that needs to be backed up.

In this embodiment of the present disclosure, in step S140, when receiving the data block that needs to be backed up, the backup storage device 30 may perform calculation, using a same fingerprint calculation method as that of the source storage device in order to obtain a fingerprint of the received data block that needs to be backed up, and store the fingerprint obtained by calculation to a storage medium, such as the storage medium 32 shown in FIG. 1 of the backup storage device 30.

Optionally, in step S130, the source storage device 20 may further send, to the backup storage device 30, the fingerprint of the data block that needs to be backed up. Correspondingly, in step S140, the backup storage device 30 directly stores the received fingerprint to the storage medium. Therefore, computing resources of the backup storage device 30 can be reduced.

Optionally, as shown in FIG. 3, the method may further include the following step.

Step S150: The backup storage device 30 feeds back a backup storage result to the source storage device 20.

The backup storage result indicates that the backup storage device 30 has successfully stored the data block that needs to be backed up.

The method shown in FIG. 3 is mainly applicable to a scenario in which the source storage device 20 and the backup storage device 30 use a same deduplication algorithm, deduplication range, and data block size. On the basis of the method shown in FIG. 3, the source storage device 20 can determine a data block that needs to be backed up in a backup period, with no engagement of the backup storage device 30. Therefore, data backup efficiency can be improved.

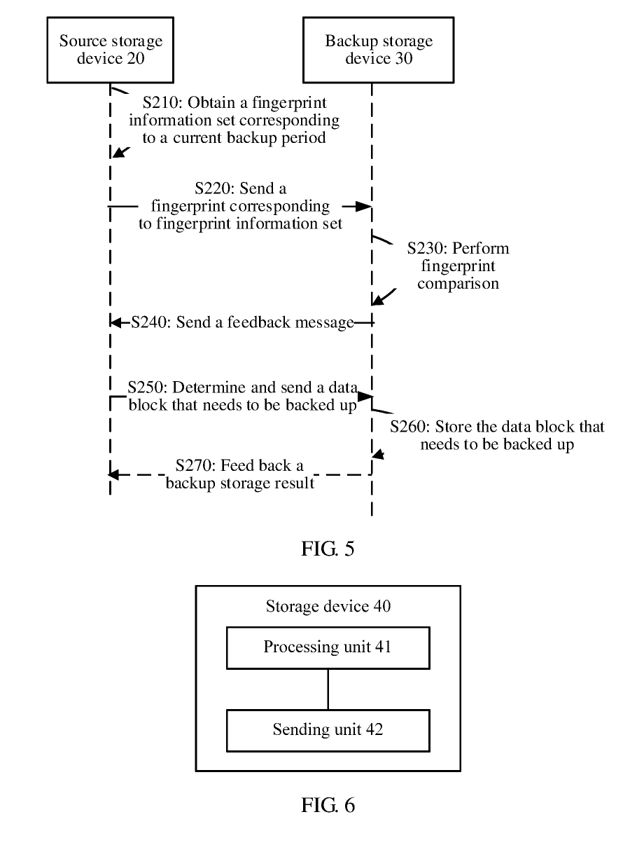

In some scenarios, a deduplication range of the source storage device 20 and a deduplication range of the backup storage device 30 are different. For example, the source storage device 20 uses a local deduplication mechanism, and the backup storage device 30 uses a global deduplication mechanism. A deduplication range defined by the local deduplication mechanism is a single storage unit, for example, a single logical unit number (LUN, or a single resource pool, while a deduplication range defined by the global deduplication mechanism is storage space of an entire system. When the backup storage device 30 uses the global deduplication mechanism, it can be understood that, in addition to backing up data blocks in the source storage device 20, the backup storage device 30 is configured to back up data blocks in another source storage device. As a result, the data block that needs to be backed up and determined by the source storage device 20 may have been stored in the backup storage device 30. Therefore, before the source storage device 20 actually sends the data block, a step of sending, to the backup storage device 30 for comparison, the fingerprint of the data block that needs to be backed up and determined by the source storage device 20 may be added. Further, as shown in FIG. 5, a method in FIG. 5 includes the following steps.

Step S210: A source storage device 20 obtains a fingerprint information set corresponding to a current backup period.

This step is the same as step S110 shown in FIG. 3. To avoid repetition, details are not described herein again.

Step S220: The source storage device 20 sends a fingerprint corresponding to the fingerprint information set to a backup storage device 30.

In step S220, a processor, such as the processor 211 shown in FIG. 2, of the source storage device 20 only needs to send, to the backup storage device 30 for fingerprint comparison, a fingerprint of the determined data block (a target data block stored by the source storage device 20 between a start moment of the current backup period and an end moment of a previous backup period, where the target data block is different from all data blocks stored by the source storage device 20 before the end moment of the previous backup period) that needs to be backed up in the current backup period. However, in the other approaches, the source storage device needs to send, to the backup storage device for fingerprint comparison, fingerprints of all data blocks included in data received by the source storage device between the start moment of the current backup period and the end moment of the previous backup period. Therefore, according to the method for differential data backup provided in this embodiment of the present disclosure, a quantity of fingerprints sent by the source storage device 20 to the backup storage device 30 can be reduced, thereby reducing consumption of network bandwidth and time consumed by the backup storage device 30 for fingerprint comparison.

Step S230: The backup storage device 30 performs fingerprint comparison, where the backup storage device 30 compares the received fingerprint with a fingerprint that has been stored by the backup storage device 30.

A difference between this embodiment and the embodiment shown in FIG. 3 lies in that in this embodiment, the backup storage device 30 receives a fingerprint sent by the source storage device 20 and compares the fingerprint with a fingerprint that has been stored by the backup storage device 30. This is not required in the embodiment shown in FIG. 3. A reason lies in that the method according to the embodiment shown in FIG. 3 is mainly applied to a scenario in which the source storage device 20 and the backup storage device 30 use a same deduplication range, while the method according to this embodiment is mainly applied to a scenario in which the source storage device 20 uses a local deduplication mechanism, and the backup storage device 30 uses a global deduplication mechanism. As described above, in the latter scenario, the data block that needs to be backed up and determined by the source storage device 20 may have been stored in the backup storage device 30. To prevent the source storage device 20 from sending an unnecessary data block to the backup storage device 30, before the source storage device 20 sends a data block to the backup storage device 30, the source storage device 20 sends, to the backup storage device 30 for comparison, the fingerprint of the data block that needs to be backed up and determined by the source storage device 20.

Step S240: The backup storage device 30 sends a feedback message to the source storage device 20.

The feedback message indicates a fingerprint comparison result in step S230. Further, the feedback message indicates a differential fingerprint. The differential fingerprint herein refers to a fingerprint in fingerprints received by the backup storage device 30 in step S220 that is not stored in the backup storage device 30. That is, the differential fingerprint is actually a fingerprint of the fingerprints received by the backup storage device 30 in step S220, and the fingerprint is different from fingerprints of data blocks stored in the backup storage device 30.

Optionally, the feedback message may indicate the differential fingerprint in an indirect manner. Further, the feedback message carries the fingerprint that already exists in the backup storage device 30 and in the fingerprints sent by the source storage device 20, and the source storage device 20 can obtain the differential fingerprint by comparing the fingerprint carried in the feedback message with the fingerprints previously sent to the backup storage device 30. The feedback message may alternatively indicate the differential fingerprint in a direct manner. Further, the feedback message carries the fingerprint in the fingerprints sent by the source storage device 20 that is not stored in the backup storage device 30, and the source storage device 20 directly determines the fingerprint carried in the feedback message as the differential fingerprint.

Step S250: The source storage device 20 determines, according to the feedback message, the data block that needs to be backed up in the current backup period, and sends, to the backup storage device 30, the determined data block that needs to be backed up.

The processor of the source storage device 20 determines, according to the fingerprint carried in the feedback message, a fingerprint, that is, the differential fingerprint, in the fingerprints sent to the backup storage device 30 in step S220 that is not stored in the backup storage device 30, obtains, according to a mapping relationship between the fingerprint and a storage address of the data block, a data block corresponding to the differential fingerprint, and sends the data blocks to the backup storage device 30 through a communications interface, such as the communications interface 215 shown in FIG. 2.

Step S260: The backup storage device 30 receives the determined data block that needs to be backed up and sent by the source storage device 20, and stores the data block that needs to be backed up.

Optionally, as shown in FIG. 5, the method may further include the following step.

Step S270: The backup storage device 30 feeds back a backup storage result to the source storage device 20.

The backup storage result indicates that the backup storage device 30 has successfully stored the data block that needs to be backed up.

The foregoing describes in detail the method for differential data backup according to the foregoing embodiments of the present disclosure with reference to FIG. 3 to FIG. 5. The following describes a storage device according to an embodiment of the present disclosure with reference to FIG. 6. The storage device is applied to a storage system, and the storage system includes the storage device and a backup storage device. As shown in FIG. 6, a storage device 40 includes a processing unit 41 and a sending unit 42.

The processing unit 41 is configured to determine, according to an identifier of a current backup period and a correspondence between an identifier of a backup period and a fingerprint information set, a fingerprint information set corresponding to the current backup period. The fingerprint information set includes fingerprint information of a target data block stored by the storage device between a start moment of the current backup period and an end moment of a previous backup period, and the target data block is different from all data blocks stored by the storage device 40 before the end moment of the previous backup period.

The processing unit 41 is further configured to obtain the target data block according to the fingerprint information of the target data block.

The sending unit 42 is configured to send the target data block to the backup storage device.

In this way, the storage device 40 according to this embodiment of the present disclosure can determine, only according to the identifier of the current backup period and the correspondence between an identifier of a backup period and a fingerprint information set, a data block that needs to be backed up in the current backup period, and send, to a backup storage device, the data block that needs to be backed up. Therefore, data backup efficiency can be improved, and consumption of computing resources and network resources can be reduced.

In this embodiment of the present disclosure, optionally, the sending unit 42 is further configured to send a fingerprint of the target data block to the backup storage device.

In this embodiment of the present disclosure, optionally, the fingerprint information of the target data block is stored in a linked list. A head node of the linked list stores the identifier of the current backup period, the i^{th} element node of the linked list stores fingerprint information of the i^{th} target data block of target data blocks, k is a total quantity of the target data blocks, and i is an integer greater than 0 and less than or equal to k.

In this embodiment of the present disclosure, optionally, the fingerprint information of the i^{th} target data block is a fingerprint of the i^{th} target data block, and the i^{th} element node of the linked list further stores a mapping relationship between the fingerprint of the i^{th} target data block and a storage address of the i^{th} target data block.

The processing unit 41 is further configured to obtain the i^{th} target data block according to the fingerprint of the i^{th} target data block and the mapping relationship between the fingerprint of the i^{th} target data block and the storage address of the i^{th} target data block.

It should be understood that the storage device 40 according to this embodiment of the present disclosure may correspond to the source storage device that executes the method in the foregoing embodiment of the present disclosure, and the foregoing and other operations and/or functions of the units of the storage device 40 are separately intended to implement procedures, in the method in FIG. 3, corresponding to the source storage device. For brevity, details are not described herein again.

In this way, the storage device 40 according to this embodiment of the present disclosure can determine, only according to the identifier of the current backup period and the correspondence between an identifier of a backup period and a fingerprint information set, a data block that needs to be backed up in the current backup period, and send, to a backup storage device, the data block that needs to be backed up. Therefore, data backup efficiency can be improved, and consumption of computing resources and network resources can be reduced.

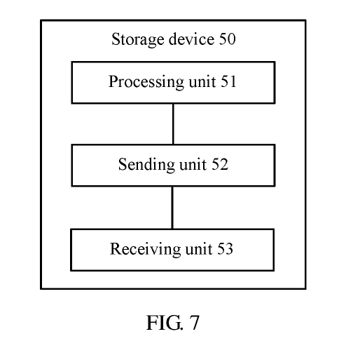

FIG. 7 shows a storage device according to another embodiment of the present disclosure. The storage device is applied to a storage system, and the storage system includes the storage device and a backup storage device. As shown in FIG. 7, a storage device 50 includes a processing unit 51, a sending unit 52, and a receiving unit 53.

The processing unit 51 is configured to determine, according to an identifier of a current backup period and a correspondence between an identifier of a backup period and a fingerprint information set, a fingerprint information set corresponding to the current backup period. The fingerprint information set includes fingerprint information of a target data block stored by the storage device 50 between a start moment of the current backup period and an end moment of a previous backup period, and the target data block is different from all data blocks stored by the storage device 50 before the end moment of the previous backup period.

The sending unit 52 is configured to send a fingerprint, corresponding to the fingerprint information of the target data block, of the target data block to the backup storage device.

The receiving unit 53 is configured to receive a feedback message sent by the backup storage device. The feedback message indicates a differential fingerprint, and the differential fingerprint is a subset of the fingerprint of the target data block and different from a fingerprint of a data block stored in the backup storage device.

The sending unit 52 is further configured to send a target data block corresponding to the differential fingerprint to the backup storage device.

In this way, the storage device 50 according to this embodiment of the present disclosure only needs to send the fingerprint of the target data block stored between the start moment of the current backup period and the end moment of the previous backup period to the backup storage device for fingerprint comparison, with no need to send fingerprints of all data blocks included in data received by the storage device 50 between the start moment of the current backup period and the end moment of the previous backup period to the backup storage device for fingerprint comparison, and determines, according to a comparison result, a data block that needs to be backed up in the current backup period. The target data block is different from all the data blocks stored by the storage device 50 before the end moment of the previous backup period. Therefore, a quantity of the fingerprints sent to the backup storage device can be reduced, thereby reducing consumption of network resources and time consumed by the backup storage device for fingerprint comparison.

In this embodiment of the present disclosure, optionally, the storage device 50 has a deduplication function, the backup storage device has a deduplication function, and a deduplication range of the storage device is less than a deduplication range of the backup storage device.

It should be understood that the storage device 50 according to this embodiment of the present disclosure may correspond to the source storage device that executes the method in the foregoing embodiment of the present disclosure, and the foregoing and other operations and/or functions of the units of the storage device 50 are separately intended to implement procedures, in the method in FIG. 5, corresponding to the storage device 50. For brevity, details are not described herein again.

In this way, the storage device 50 according to this embodiment of the present disclosure only needs to send the fingerprint of the target data block stored between the start moment of the current backup period and the end moment of the previous backup period to the backup storage device for fingerprint comparison, with no need to send fingerprints of all data blocks included in data received by the storage device 50 between the start moment of the current backup period and the end moment of the previous backup period to the backup storage device for fingerprint comparison, and determines, according to a comparison result, a data block that needs to be backed up in the current backup period. The target data block is different from all the data blocks stored by the storage device 50 before the end moment of the previous backup period. Therefore, a quantity of the fingerprints sent to the backup storage device can be reduced, thereby reducing consumption of network resources and time consumed by the backup storage device for fingerprint comparison.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described.

In the several embodiments provided in this application, it should be understood that the disclosed system, apparatus, and method may be implemented in other manners. For example, the described apparatus embodiment is only an example. For example, the unit division is only logical function division and may be other division in actual implementation. For example, a plurality of units or components may be combined or integrated into another system, or some features may be ignored or not performed. In addition, the displayed or discussed mutual couplings or direct couplings or communication connections may be indirect couplings or communication connections between some interfaces, apparatuses, and units, or may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

The functions may be stored in a computer-readable storage medium when the functions are implemented in the form of a software functional unit and sold or used as an independent product. Based on such an understanding, the technical solutions of the present disclosure essentially, or the part contributing to the other approaches, or some of the technical solutions may be implemented in a form of a software product. The software product is stored in a storage medium, and includes several instructions for instructing a computer device, which may be a personal computer, a server, or a network device, to perform all or some of the steps of the methods described in the embodiments of the present disclosure. The foregoing storage medium includes any medium that can store program code, such as a universal serial bus (USB) flash drive, a removable hard disk, a read-only memory (ROM), a RAM, a magnetic disk, or an optical disc.

The foregoing descriptions are only specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for a source storage device replicating data to a backup storage device over a plurality of backup periods, comprising:
identifying, by the source storage device, a current fingerprint set from a plurality of fingerprint sets based on an identifier of a current backup period, wherein each of the plurality of fingerprint sets corresponds to a backup period, wherein the current fingerprint set comprises one or more fingerprints, which identifies one or more data blocks respectively, and wherein the one or more data blocks are received by the source storage device between an end moment of a previous backup period and a start moment of the current backup period;
obtaining, by the source storage device, the one or more data blocks based on the one or more fingerprints; and
sending, by the source storage device, the one or more data blocks to the backup storage device.

2. The method according to claim 1, wherein the one or more fingerprints has not been stored in history fingerprints sets of the plurality of fingerprint sets.

3. The method according to claim 1, wherein the previous backup period is a latest history backup period.

4. The method according to claim 1, further comprising sending, by the source storage device, the one or more fingerprints to the backup storage device.

5. The method according to claim 1, wherein the current fingerprint set comprises a linked list comprising a head node and one or more element nodes, wherein the head node stores the identifier of the current backup period, and wherein each of the one or more element nodes stores a fingerprint of the one or more fingerprints.

6. The method according to claim 5, wherein each of the one or more element nodes further comprises a mapping between the fingerprint and a storage address of a data block identified by the fingerprint.

7. A source storage device, comprising:
a memory comprising instructions and configured to store a plurality of fingerprint sets, wherein each of the plurality of fingerprint sets corresponds to a backup period; and
a processor coupled to the memory, wherein the instructions cause the processor to be configured to:
identify a current fingerprint set from the plurality of fingerprint sets based on an identifier of a current backup period, wherein the current fingerprint set comprises one or more fingerprints, which identifies one or more data blocks respectively, and wherein the one or more data blocks are received by the source storage device between an end moment of a previous backup period and a start moment of the current backup period;
obtain the one or more data blocks based on the one or more fingerprints; and
send the one or more data blocks to the backup storage device.

8. The source storage device according to claim 7, wherein the one or more fingerprints has not been stored in history fingerprints sets of the plurality of fingerprint sets.

9. The source storage device according to claim 7, wherein the previous backup period is a latest history backup period.

10. The source storage device according to claim 7, wherein the instructions further cause the processor to be configured to send the one or more fingerprints to the backup storage device.

11. The source storage device according to claim 7, wherein the current fingerprint set comprises a linked list which comprises a head node and one or more element nodes, wherein the head node stores the identifier of the current backup period, and wherein each of the one or more element nodes stores a fingerprint of the one or more fingerprints.

12. The source storage device according to claim 11, wherein each of the one or more element nodes further comprises a mapping between the fingerprint and a storage address of a data block identified by the fingerprint.
